(19) United States
(12) Patent Application Publication
(10) Pub. No.: US 2026/0014838 A1
(43) Pub. Date: Jan. 15, 2026

(54) U-SHAPED PANORAMIC SUN BLIND ASSEMBLY WITHOUT REAR-BEAM SUPPORT

(71) Applicant: Kunshan Yuqiu Molding Plastics Co., Ltd, Suzhou (CN)

(72) Inventors: Pei ZHANG, Suzhou (CN); Chitsai FANG, Suzhou (CN); Yonghao PAN, Suzhou (CN)

(21) Appl. No.: 18/815,408

(22) Filed: Aug. 26, 2024

(30) Foreign Application Priority Data
Jul. 15, 2024 (CN) 2024109434917

(51) Int. Cl. B60J 3/02

(52) U.S. Cl. CPC B60J 3/0234

(57) ABSTRACT

A U-shaped panoramic sun blind assembly is disclosed, which includes a sunroof assembly, and a roof with a second guide rail at one end thereof and a first guide rail at another end thereof for a movement of a sunshade. A plurality of fixing pieces are fixed at each of two sides of front ends of the roof and the sunroof assembly respectively for mounting. A motor is positioned at an inside of the front end of the sunroof assembly for driving the sunshade. A plurality of fixing clamp seats are secured to an edge of each of the first and second guide rail respectively. A switch is positioned at a center of the front end of the roof for controlling the sunshade. A sunshade assembly is movably mounted between the first and second guide rail. A crossbeam bracket is mounted to a surface of the front end of the roof.

### CROSS-REFERENCE TO RELATED APPLICATION

The present application claims priority to Chinese patent application No. 202410943491.7, filed on July 15, 2024, the content of which is incorporated herein by reference in its entirety.

### TECHNICAL FIELD

The present disclosure relates to the field of panoramic roof, in particular to a U-shaped panoramic sun blind assembly without rear-beam support.

### BACKGROUND

A panoramic sun blind assembly is a supporting device for controlling opening and closing of sunroof of a vehicle. A panoramic roof of a vehicle refers to a large glass panel covering an entire roof of a vehicle. This design primarily aims to enhance lighting inside the vehicle and improve a driving experience, offering a larger area that allows more sunlight to penetrate the vehicle, thus increasing brightness inside the vehicle. Moreover, the panoramic roof design elevates spaciousness and luxury of the vehicle. With a continuous development of technology, there is an increasing demand for more sophisticated manufacturing techniques in panoramic roof assemblies.

Related panoramic roof assemblies have certain drawbacks. Firstly, they may obstruct a driver's rearward visibility, thereby representing a safety hazard, and making against people's use. Additionally, the related panoramic roof assemblies cannot be installed or serviced easily and quickly, thereby adversely affecting a user’s experience.

### SUMMARY

A U-shaped panoramic sun blind assembly without rear-beam support is provided, which may include a sunroof assembly, and a roof with a second guide rail mounted at one end of the roof and a first guide rail mounted at another end of the roof for a movement of a sunshade. A plurality of fixing pieces are fixed at each of two sides of front ends of the roof and the sunroof assembly respectively for mounting. A motor for driving the sunshade is positioned at an inside of the front end of the sunroof assembly. A plurality of fixing clamp seats are secured to an edge of each of the first guide rail and the second guide rail respectively. A switch is positioned at a center of the front end of the roof for controlling the sunshade. A sunshade assembly is movably mounted between the first guide rail and the second guide rail. A crossbeam bracket is mounted to a surface of the front end of the roof.

In an embodiment, a limit sealing frame is fixed between rear ends of the first guide rail and the second guide rail for limiting, a positioning protective shell is positioned outside the motor on the sunroof assembly, the motor is connected with a control cable, a plurality of groups of buckle seats are positioned outside the control cable on the sunroof assembly, and a roof cover is clamped at an outer side of the roof.

In an embodiment, two fixing pieces at the front end of the sunroof assembly are inserted into a gap of the roof in a vehicle body, and the plurality of fixing clamp seats at the each of the first guide rail and the second guide rail are inserted into the gap of the roof in the vehicle body, each of the fixing clamp seats is fastened by a self-tapping screw, the roof is attached to a frame of a vehicle for installation, and the switch is clamped on the roof for installation.

In an embodiment, the sunshade assembly between the first guide rail and the second guide rail is unfolded to extend from a front of a vehicle to a rear of the vehicle, and the unfolded sunshade assembly does not affect a viewing angle of a rearview mirror.

In an embodiment, the whole sunroof assembly adopts a back-beam free structure.

In an embodiment, when the U-shaped panoramic sun blind assembly without rear-beam support is fixed to a vehicle, two groups of fixing pieces are inserted between an existing trim panel of a vehicle body and glass, and the plurality of fixing clamp seats at each of two sides fix the sunroof assembly between a C-pillar trim panel and glass.

In an embodiment, when the sunroof assembly is locked and attached to two groups of fixing pieces, an opening size of the sunroof assembly is capable of being finely adjusted by a screw.

In an embodiment, the sunroof assembly is fixed on a vehicle body, and the roof cover is fixed on the sunroof assembly and the roof by a mushroom buckle or a fastener.

### BRIEF DESCRIPTION OF DRAWINGS

FIG. 1 is a schematic diagram of an overall structure of a U-shaped panoramic sun blind assembly without rear-beam support.

FIG. 2 is a schematic diagram of another overall structure of the U-shaped panoramic sun blind assembly without rear-beam support.

FIG. 3 is a schematic diagram of still another overall structure of the U-shaped panoramic sun blind assembly without rear-beam support.

FIG. 4 is a schematic diagram of a side view of the U-shaped panoramic sun blind assembly without rear-beam support.

FIG. 5 is a schematic diagram of the U-shaped panoramic sun blind assembly without rear-beam support after installation.

FIG. 6 is a schematic diagram of an enlarged view at A of the U-shaped panoramic sun blind assembly without rear-beam support.

Reference numerals: 1, roof; 2, switch; 3, motor; 4, crossbeam bracket; 5, fixing clamp seat; 6, first guide rail; 7, sunshade assembly; 8, second guide rail; 9, fixing piece; 10, positioning protective shell; 11, buckle seat; 12, control cable; 13, limit sealing frame; 14, roof cover; 15, sunroof assembly.

### DETAILED DESCRIPTION

Technical schemes of the present disclosure will be described with accompany drawings and specific embodiments, but those having ordinary skill in the art will understand that the embodiments described below are part of the embodiments of the present disclosure, but not all of them, and are only used to illustrate the present disclosure and should not be regarded as limiting a scope of the present disclosure. Based on the embodiments in the present disclosure, all other embodiments obtained by those having ordinary skill in the art without creative labor belong to the scope of protection of the present disclosure. Where specific conditions are not specified in examples, it shall be carried out according to conventional conditions or conditions suggested by the manufacturer. Reagents or instruments used, whose manufacturer is not indicated, are all conventional products that can be purchased in the market.

In a description of the present disclosure, it should be noted that orientations or positional relationships indicated by terms such as "center", "up", "down", "left", "right", "vertical", "horizontal", "inner" and "outer" are based on the orientation or the positional relationship shown in the accompany drawings, and are only for a convenience of describing the present disclosure and simplifying the description, and are not intended to indicate or imply that a device or an element referred to must have a particular orientation, be constructed and operated in a particular orientation. In addition, terms such as "first", "second" and "third" are only used for descriptive purposes and cannot be understood as indicating or implying relative importance.

In the description of the present disclosure, it should be noted that unless otherwise specified and limited, terms such as "install", “couple” and "connect" should be broadly understood, for example, they may refer to a fixed connection, a detachable connection or an integrated connection; or may be a mechanical connection or an electrical connection; or may be a direct connection, indirect connection through an intermediate medium, or connection inside two elements. For those skilled in the art, specific meanings of the above terms in the present disclosure can be understood in specific situations.

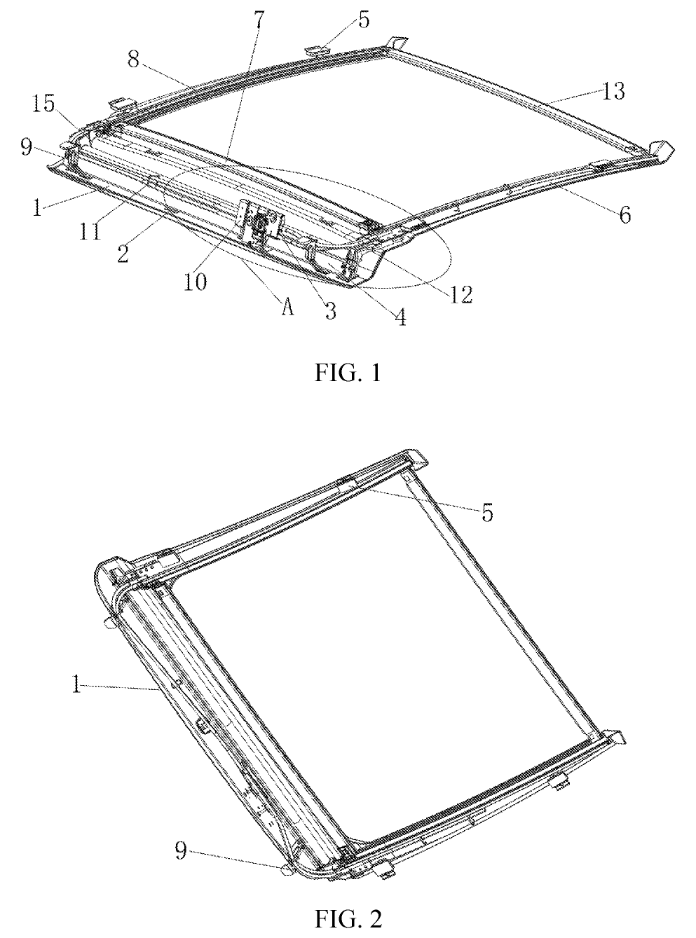

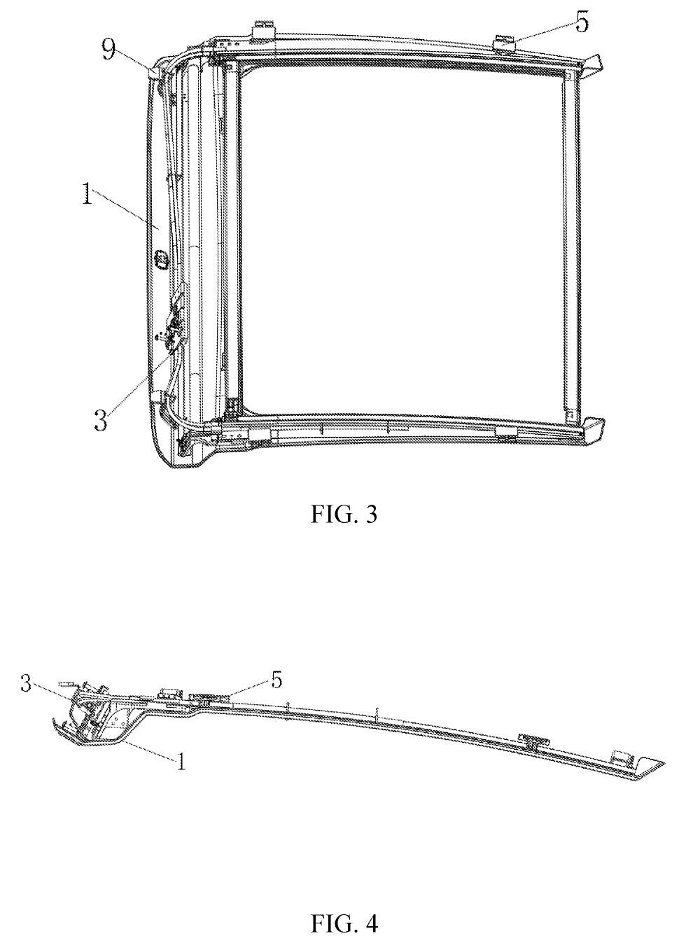

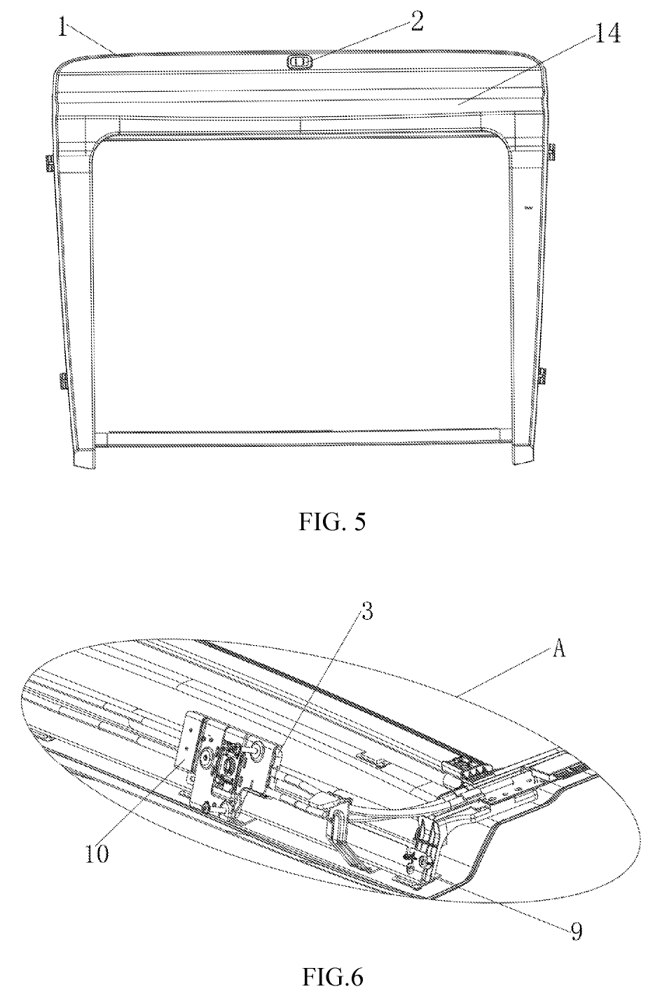

As shown in FIGS. 1 to 6, a U-shaped panoramic sun blind assembly without rear-beam support includes a sun roof assembly 15, and a roof 1 having a second guide rail 8 mounted at one end of the roof 1 and a first guide rail 6 mounted at another end of the roof 1 for a movement of a sunshade. A plurality of fixing pieces 9 are fixed at each of two sides of front ends of the roof 1 and the sunroof assembly 15 respectively for installation. A motor 3 is positioned at an inside of the front end of the sunroof assembly 15 for driving the sunshade. A plurality of fixing clamp seats 5 are secured to an edge of each of the first guide rail 6 and the second guide rail 8 respectively. A switch 2 is positioned at a center of the front end of the roof 1 for controlling the sunshade. A sunshade assembly 7 is movably mounted between the first guide rail 6 and the second guide rail 8. A crossbeam bracket 4 is mounted to a surface of the front end of the roof 1. The sunroof assembly is U-shaped, and its opening tilts towards a rear of a vehicle. Such a unique U-shaped frame can be utilized in a vehicle where a rear window and sunroof glass are integrated together, thereby blocking sunshine, reducing a temperature within the vehicle while preventing a rearview mirror from being obscured, ensuring a driving safety.

In an embodiment, a limit sealing frame 13 is fixed between rear ends of the first guide rail 6 and the second guide rail 8 for limiting. A positioning protective shell 10 is positioned outside the motor 3 on the sunroof assembly 15. The motor 3 is connected with a control cable 12. A plurality of groups of buckle seats 11 are positioned outside the control cable 12 on the sunroof assembly 15. A roof cover 14 is clamped at an outer side of the roof 1.

In an embodiment, two fixing pieces 9 at the front end of the sunroof assembly 15 are inserted into a gap of the roof 1 in a vehicle body. The plurality of fixing clamp seats 5 at the each of the first guide rail 6 and the second guide rail 8 are inserted into the gap of the roof 1 in the vehicle body. Each of the plurality of fixing clamp seats 5 is fastened by a self-tapping screw respectively. The roof 1 is attached to a frame of a vehicle for installation, and the switch 2 is clamped on the roof 1 for installation.

In an embodiment, the sunshade assembly 7 between the first guide rail 6 and the second guide rail 8 is unfolded to extend from a front of a vehicle to a rear of the vehicle, and the unfolded sunshade assembly 7 does not prevent the driver from watching a rearview mirror.

In an embodiment, the whole sunroof assembly 15 adopts a back-beam free structure.

In an embodiment, when the U-shaped panoramic sun blind assembly without rear-beam support is fixed into a vehicle, two groups of fixing pieces 9 are inserted between an existing trim panel of a vehicle body and glass, and the plurality of fixing clamp seats 5 at each of two sides fix the sunroof assembly 15 between a C-pillar trim panel and glass.

In an embodiment, when the sunroof assembly 15 is locked and attached to the fixing pieces 9, an opening size of the sunroof assembly 15 is capable of being finely adjusted by a screw.

In an embodiment, the sunroof assembly 15 is fixed on a vehicle body, and the roof cover 14 is fixed on the sunroof assembly 15 and the roof 1 by a mushroom buckle or a fastener.

During installation, two brackets in front of the sunroof assembly are inserted into the gap of the roof of the vehicle body, then the fixing clamp seats are inserted into the gap of the roof of the vehicle body, and fastened with the self-tapping screws from a back seat of the vehicle, and the roof is attached to the frame. Finally, the switch is clamped on the roof to complete the installation.

A working principle is as follows. The present disclosure includes the roof 1, the switch 2, the motor 3, the crossbeam bracket 4, the fixing clamp seats 5, the first guide rail 6, the sunshade assembly 7, the second guide rail 8, the fixing pieces 9, the positioning protective shell 10, the buckle seats 11, the control cable 12, the limit sealing frame 13, the roof cover 14 and the sunroof assembly 15. The sunroof assembly is U-shaped, and its opening tilts towards the rear of the vehicle. A unique U-shaped frame can be utilized in the vehicle where the rear window and sunroof glass are integrated together, thereby blocking sunshine, reducing the temperature within the vehicle while preventing the rearview mirror from being obscured, ensuring the driving safety.

In this design, the sunshade is unfolded to extend from the front of the vehicle to the rear of the vehicle.

In this design, the unfolded sunshade does not prevent the driver from watching the rearview mirror.

Such a rear-beam free design solves a problem about a viewing angle of rearview mirror, reduces the number of the required components, cost and weight.

A fixation manner is as followings. Two fixing pieces are inserted between the existing trim panel of the vehicle body and glass, and the plurality of fixing clamp seats fix the sunroof assembly between the C-pillar trim panel and the glass at each of two sides (optionally, more than two fixing clamp seats at one side), which has advantages of easy and non-destructive installation. When the sunroof assembly is locked and attached to the fixing pieces, the opening size of the sunroof assembly is capable of being finely adjusted by a screw (optionally, more than two on one side), thereby avoiding damaging frame parallelism due to body differences and affecting a product function.

The frame is fixed on the vehicle body, and sunroof assembly is fixed on the frame by the mushroom buckle or the fastener, thus realizing integration of appearance matching.

Technical problems solved by this disclosure are as follows. The present disclosure provides a U-shaped panoramic sun blind assembly without rear-beam support. The sunroof assembly is U-shaped, and its opening tilts towards a rear of a vehicle. A unique U-shaped frame can be utilized in a vehicle where a rear window and sunroof glass are integrated together, thereby blocking sunshine, reducing a temperature within the vehicle while preventing a rearview mirror from being obscured, maintaining a driving safety and effectively solving the problems identified in the background section.

Compared with the related technology, the present disclosure provides the U-shaped rear-beam free panoramic sun blind assembly having following beneficial effects. The sunroof assembly is U-shaped, and its opening tilts towards a rear of a vehicle. A unique U-shaped frame can be utilized in the vehicle where a rear window and sunroof glass are integrated together, thereby blocking sunshine, reducing a temperature within the vehicle while preventing a rearview mirror from being obscured, ensuring a driving safety. In this design, the sunshade is unfolded to extend from the front of the vehicle to the rear of the vehicle. In this design, the unfolded sunshade does not prevent the driver from watching the rearview mirror. A rear-beam free design solves a problem about a viewing angle of rearview mirror, reduces the number of required components, cost and weight. Two fixing pieces are inserted between the existing trim panel of the vehicle body and glass, and the plurality of fixing clamp seats fix the sunroof assembly between the C-pillar trim panel and the glass at each of two sides (optionally, more than two fixing clamp seats at one side), which has advantages of easy and non-destructive installation. When the sunroof assembly is locked and attached to the fixing pieces, the opening size of the sunroof assembly is capable of being finely adjusted by the screws (optionally, more than two screws on one side), thereby voiding damaging frame parallelism due to body differences and affecting a product function. The frame is fixed on the vehicle body, and sunroof assembly is fixed on the frame by the mushroom buckle or the fastener, thus realizing integration of appearance matching. The whole panoramic sun blind assembly is simple in structure, convenient to operate and better in use effect than the traditional panoramic roof.

It should be noted that in this disclosure, relational terms such as "first" and "second" are only used to distinguish one entity or operation from another entity or operation, and do not necessarily require or imply that there is any such actual relationship or order between these entities or operations. Moreover, the terms such as "include", "comprise" or any other variation thereof are intended to cover non-exclusive inclusion, so that a process, method, article or equipment including a series of elements includes not only those elements, but also other elements not explicitly listed or elements inherent to such process, method, article or equipment. Without further restrictions, an element defined by the phrase "including one" does not exclude existences of other identical elements in the process, method, article or equipment including the element.

The basic principle, main features and advantages of the present disclosure have been shown and described above. It should be understood by those skilled in the art that the present disclosure is not limited by above mentioned embodiments, and what is described in the abovementioned embodiments and descriptions only illustrates principles of the present disclosure. Without departing from a scope of the present disclosure, there will be various changes and improvements in the present disclosure, which fall within a scope of claims.

What is claimed is:

1. A U-shaped panoramic sun blind assembly without rear-beam support, comprising a sunroof assembly, and a roof with a second guide rail mounted at one end of the roof and a first guide rail mounted at another end of the roof for a movement of a sunshade, wherein, a plurality of fixing pieces are fixed at each of two sides of front ends of the roof and the sunroof assembly respectively for mounting, a motor is positioned at an inside of the front end of the sunroof assembly for driving the sunshade, a plurality of fixing clamp seats are secured to an edge of each of the first guide rail and the second guide rail respectively, a switch is positioned at a center of the front end of the roof for controlling the sunshade, a sunshade assembly is movably mounted between the first guide rail and the second guide rail, and a crossbeam bracket is mounted to a surface of the front end of the roof.

2. The U-shaped panoramic sun blind assembly without rear-beam support of claim 1, wherein, a limit sealing frame is fixed between rear ends of the first guide rail and the second guide rail for limiting, a positioning protective shell is positioned outside the motor on the sunroof assembly, the motor is connected with a control cable, a plurality of groups of buckle seats are positioned outside the control cable on the sunroof assembly, and a roof cover is clamped at an outer side of the roof.

3. The U-shaped panoramic sun blind assembly without rear-beam support of claim 1, wherein, two fixing pieces at the front end of the sunroof assembly are inserted into a gap of the roof in a vehicle body, the plurality of fixing clamp seats at the each of the first guide rail and the second guide rail are inserted into the gap of the roof in the vehicle body, each of the fixing clamp seats are fastened by a self-tapping screw respectively, the roof is attached to a frame of a vehicle for installation, and the switch is clamped on the roof for installation.

4. The U-shaped panoramic sun blind assembly without rear-beam supports of claim 1, wherein, the sunshade assembly between the first guide rail and the second guide rail is capable of being unfolded to extend from a front of a vehicle to a rear of the vehicle without obstructing a rearview mirror.

5. The U-shaped panoramic sun blind assembly without rear-beam supports of claim 1, wherein, the whole sunroof assembly adopts a back-beam free structure.

6. The U-shaped panoramic sun blind assembly without rear-beam supports of claim 1, wherein, in response to fixing the U-shaped panoramic sun blind assembly without rear-beam supports to a vehicle, two groups of fixing pieces are inserted between an existing trim panel of a vehicle body and glass, and the plurality of fixing clamp seats at each of two sides fix the sunroof assembly between a C-pillar trim panel and glass.

7. The U-shaped panoramic sun blind assembly without rear-beam supports of claim 1, wherein, in response to the sunroof assembly being locked and attached to two groups of fixing pieces, an opening size of the sunroof assembly is capable of being finely adjusted by at least one of screws.

8. The U-shaped panoramic sun blind assembly without rear-beam supports of claim 2, wherein, the sunroof assembly is fixed on a vehicle body, and the roof cover is fixed on the sunroof assembly and the roof by a mushroom buckle or a fastener.
